(19) United States
(12) Patent Application Publication
(10) Pub. No.: US 2022/0244911 A1
(43) Pub. Date: Aug. 4, 2022

(54) DIGITAL CIRCUITRY FOR NORMALIZATION FUNCTIONS

(71) Applicant: Microsoft Technology Licensing, LLC, Redmond, WA (US)

(72) Inventors: Torsten Hoefler, Zurich (CH); Mattheus C Heddes, Woodinville, WA (US)

(21) Appl. No.: 17/163,225

(22) Filed: Jan. 29, 2021

(51) Int. Cl. G06F 5/01; G06N 3/063

(52) U.S. Cl. CPC G06F 5/012; G06N 3/063

(57) ABSTRACT

The present disclosure includes digital circuits that generate values of a power of two (2) raised to an input value. For example, a digital circuit may include combinational logic that receives first digital bits representing an input mantissa of an input value and second digital bits representing an input exponent of the input value. The combinational logic generates a plurality of output mantissas and plurality of output exponents corresponding to an approximate value of a power of two (2) raised to a power of the input value when the input value is positive and negative and when the input exponent is above and below a first value. Selection circuits are configured to receive output mantissas and output exponents. The selection circuits include selection control inputs coupled to the input exponent and an input sign bit of the input value to select one of the output mantissas and one output exponents.

### BACKGROUND

The present disclosure relates to computing, and more particularly, to digital circuits for normalization functions.

Artificial neural networks (hereinafter, neural network) have become increasingly important in artificial intelligence applications and modern computing in general. An example neural network is shown in FIG. 1. Neural network 100 receives input values corresponding to features to be recognized. The input values are multiplied by weights (represented by edges 101) and added together (e.g., summed) in nodes 102. An activation function is applied to the result in the nodes 102 to generate an output value. Values are combined across multiple nodes and layers of nodes to produce network output values corresponding to a result.

Such systems “learn” to perform tasks by considering examples, generally without being programmed with task-specific rules. Initially, the weights may be untrained. During a training phase, input values for corresponding known results are processed by the network, and the difference (or error) between the network output values is compared to known values. The weights may be adjusted based on the error using a process known as backpropagation, where computations flow in the reverse direction (e.g., from the output to the input). Training may involve successively adjusting weights across many input samples and corresponding known network output values. This is often referred to as the training phase. Once trained, the system may receive inputs and produce meaningful results (e.g., classification or recognition). This is often referred to as the inference phase.

As the popularity of neural networks has increased, so to has the complexity of problems neural networks are being used to solve. As the complexity of the problems increases, the size and computational complexity of the networks has increased. One common and very time-consuming operation in a neural network is normalization. For example, as activations and weights are multiplied and summed across nodes of a network, it is common to normalize the results. Softmax is an example of one such normalization function. Softmax may be used as the last activation function of a neural network to normalize the output of a network to a probability distribution over predicted output classes, for example. However, normalization functions often require complex numerical calculations that can slow down the network. The disclosure presented herein provides digital circuits and processing techniques that may be used in normalization functions (and other applications) more efficiently.

Various embodiments, examples, and advantages are described in the detailed description below.

### BRIEF DESCRIPTION OF THE DRAWINGS

Various embodiments of the present disclosure are illustrated by way of example and not limitation in the figures of the accompanying drawings.

FIG. 1 illustrates an example neural network.

FIG. 2 illustrates a digital circuit according to an embodiment.

FIG. 3 illustrates a digital circuit according to another embodiment.

FIG. 4 illustrates an example digital circuit for generating approximations of 2^{x} according to another embodiment.

FIG. 5A illustrates an example digital circuit for generating approximations of 4^{X} according to another embodiment.

FIG. 5B illustrates another example digital circuit for generating approximations of 4^{x} according to another embodiment.

FIG. 6 illustrates a normalization system according to an embodiment.

FIG. 7 illustrates a method according to an embodiment.

FIG. 8 illustrates a neural network processing system according to some embodiments.

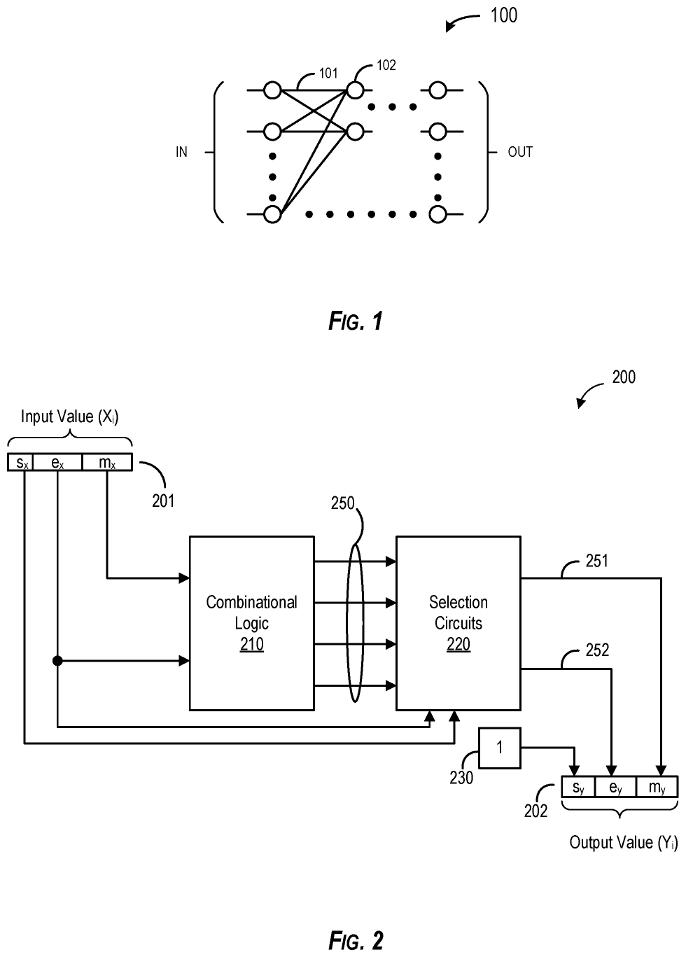

### DETAILED DESCRIPTION

In the following description, for purposes of explanation, numerous examples and specific details are set forth in order to provide a thorough understanding of the present disclosure. Such examples and details are not to be construed as unduly limiting the elements of the claims or the claimed subject matter as a whole. It will be evident to one skilled in the art, based on the language of the different claims, that the claimed subject matter may include some or all of the features in these examples, alone or in combination, and may further include modifications and equivalents of the features and techniques described herein.

Features and advantages of the present disclosure include a digital circuit that receives input values (e.g., floating point) and produces output values corresponding to an approximate value of a power of two (2) (e.g., 2, 4, . . . ) raised to a power of the input value x (e.g., 2^{x}, 4^{x}, etc. . . . ). As described in more detail below, the Softmax function may be approximated using such functions. Advantageously, such functions may be implemented in combinational digital logic, which may be able to generate outputs without waiting for multiple clock cycles, for example. Accordingly, some example embodiments may be able to generate outputs based only on a present input, in contrast to sequential logic, in which the output depends not only on the present input but also on the prior inputs (e.g., data is stored). This may result in faster, lower latency systems which may implement many approximations of the Softmax function, for example.

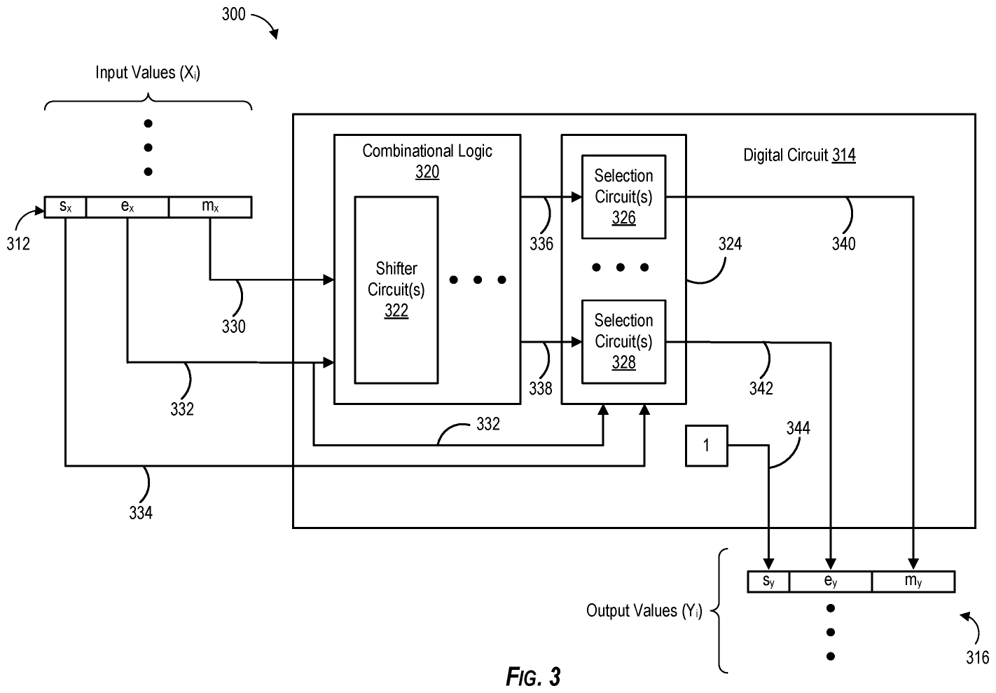

FIG. 2 illustrates a digital circuit 200 according to an embodiment. Circuit 200 receives an input value 201 in a floating point representation. Input value (Xi) 201 comprises an input exponent (eₓ), input mantissa (mₓ), and an input sign bit (sₓ) represented as digital bits. Digital circuit 200 comprises combinational logic 210 which receives the digital bits representing an input mantissa mₓ and digital bits representing an input exponent eₓ and generates a plurality of output mantissas and plurality of output exponents 250 corresponding to an approximate value of a power of two (2) raised to a power of the input value. In one example embodiment, combinational logic 210 generates a plurality of shifted versions of the input mantissa, where the input mantissa is shifted based on the input exponent to produce the output mantissas and output exponents. Advantageously, separate output mantissas and output exponents may be generated across four quadrants, for example, when the input value is positive and negative and when the input exponent is above and below a first value.

Digital circuit 200 further includes selection circuits 220. Selection circuits 220 are configured to receive the output mantissas and output exponents 250 and produce one final output mantissa 251 and one final output exponent 252. Accordingly, embodiments of the present disclosure may include two or more selection circuits, such as multiplexers, in selection circuits 220, for example. Selection circuits 220 may include selection control inputs coupled to the input exponent and an input sign bit of the input value (Xi). As illustrated here and in further embodiments below, features of the present disclosure include selecting one of the output mantissas as the final output mantissa 251 and selecting one of the output exponents as the final output exponent 252 based on the input exponent and the input sign bit. Since digital circuit 200 implements an approximate value of a power of two (2) raised to a power of the input value (e.g., N^{X}, N=2, 4, 8, 16, . . . ), the output sign bit is constant value 1, and may be hardwired at 230, for example. Thus, the output value (Yi) 202 generated by digital circuit 200 may also be a floating point value comprising an exponent (e_{y}), mantissa (m_{y}), and a sign bit (s_{y}). Advantageously, in some embodiments, streams of input values (Xi) may be converted to output values (Yi) very quickly (e.g., on each clock cycle) for efficient computation of an approximation of the Softmax function, for example.

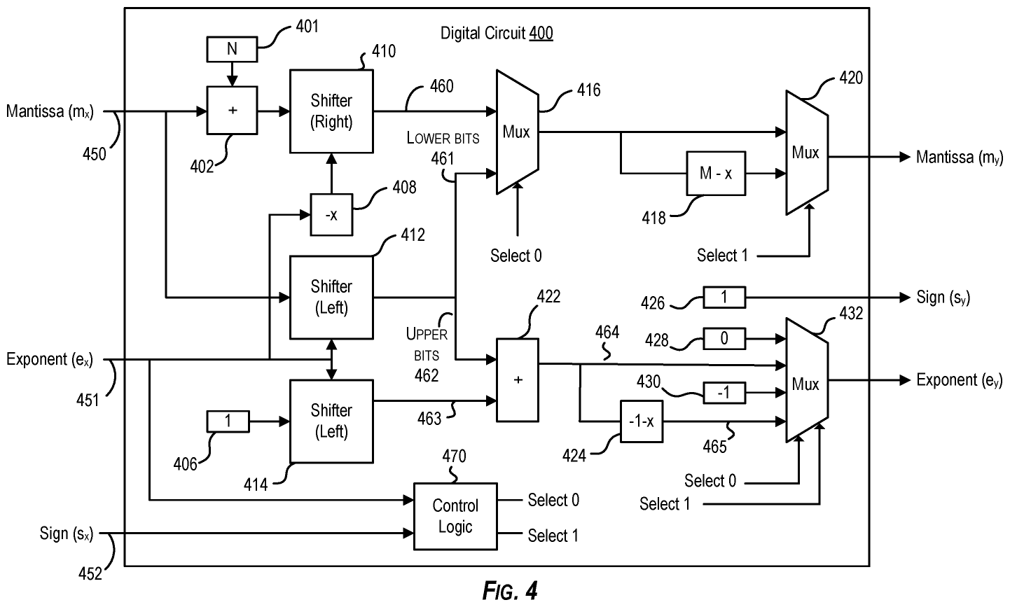

FIG. 3 illustrates a digital circuit according to another embodiment. Features and advantages of the present disclosure include shifting the mantissa of the input value based on the exponent to produce output mantissas and output exponents, which may then be selected based on the input exponent and input sign bit. In this example, digital circuit 314 receives input values 312 comprising an input sign bit, input exponent, and input mantissa and produce an output value 316 approximately equal to a power of two (2) raise to the power of the input (e.g., 2^{x}, 4^{X}) comprising an output sign bit, output exponent, and output mantissa. Digital circuit 314 includes combinational logic 320, which in this example includes shifter circuits 322. A plurality of shifter circuits may receive in the input mantissa and input exponent, for example. Features and advantages of the present disclosure include shifting the input mantissa 330 based on the input exponent 332 to produce a plurality of output manitssas 336 and output exponents 338, which are coupled to selection circuits 326 and 328 for selection one output mantissa/exponent pair as the final outputs based on the input sign bit 334 and input exponent 332. The shifter circuits may produce left and right shifted versions of the input mantissa. For example, a right shifter circuit may include a first input coupled to the input mantissa 330 through a logic circuit configured to add the input mantissa to a constant and a shift input coupled to the input exponent 332 through a logic circuit configured to negate the input exponent. Additionally, a first left shifter circuit may include a first input coupled to receive the input mantissa 330 and a shift input coupled to the input exponent 332, for example. A right shifted version of the input mantissa may be used to form a first output mantissa and a second output mantissa, and lower bits of a left shifted version of the input mantissa may be used to form a third output mantissa and a fourth output mantissa. Further, upper bits of a left shifted version of the input mantissa may be used to form a first output exponent and a second output exponent. Further examples and illustrations of these techniques are provided below.

In some example embodiments, the shifter circuits are barrel shifter circuits, which is a digital circuit that can shift a data word by a specified number of bits using combinational logic (e.g., without the use of any sequential logic and associated delays from storing data over time). Barrel shifters may be advantageous in applications where it is desirable to obtain a result on a single clock cycle, for example.

Each output mantissa 336 may have an associated output exponent 338, for example, corresponding to a particular pair of values for the input exponent 332 and input sign bit 334 (e.g., 4 sets of tuples for sₓ greater than or less than 1, and eₓ greater than or less than 0 or −1). Selection circuits 326 and 328 are controlled by the input exponent 332 and input sign bit 334. Accordingly, a final output mantissa 340 and final output exponent 342 may be selected from the plurality of output mantissas 336 and output exponents 338 based on the input exponent 332 and input sign bit 334.

Accordingly, selection circuits 326 may produce different output mantissas, and selection circuits 328 may produce different output exponents, based on the input sign bit and input exponent. First, selection circuits 326 and 328 may produce a final output mantissa comprising a shifted version of a sum of the input mantissa and a constant and an output exponent having a zero value (0) when the input sign bit is positive and the input exponent is less than a first value (e.g., 0 or −1). Second, selection circuits 326 and 328 may produce a final output mantissa comprising a modulus of another shifted version of the input mantissa and a final output exponent having a digital value of one (1) shifted based on the input exponent added to an integer division of the shifted version of the input mantissa when the input sign bit is positive and the input exponent is greater than the first value. Third, selection circuits 326 and 328 may produce a final output mantissa comprising the first shifted version of the sum of the input mantissa and a constant, subtracted from a second constant, and a final output exponent having negative one (−1) value when the input sign bit is negative and the input exponent is less than the first value. Finally, selection circuits 326 and 328 may produce a final output mantissa comprising a modulus of the second shifted version of the input mantissa, subtracted from the second constant, and a negation of the second output exponent minus one (1) when the input sign bit is negative and the input exponent is greater than the first value. Various example implementations and further illustrations of the above techniques are provided below.

### Example Implementations

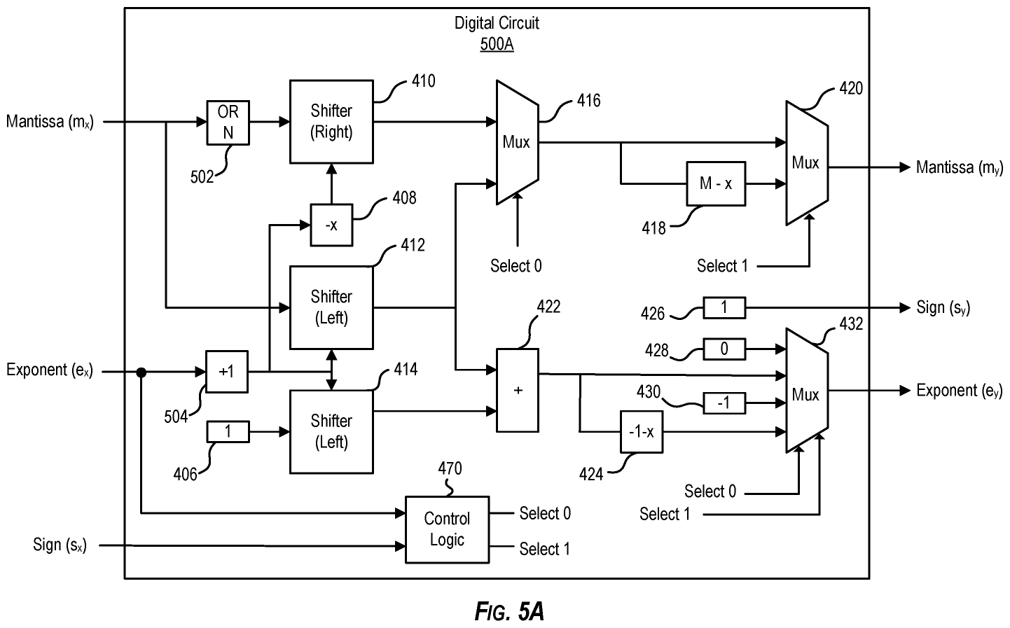

FIG. 4 illustrates an example digital circuit 400 for generating approximations of 2^{x} according to another embodiment. Digital circuit 400 includes right shifter circuit 410, left shifter circuit 412, and left shifter circuit 414. Input mantissa 450 is coupled to an adder circuit 402. Adder circuit 402 further receives a constant value (N) 401 and outputs a sum of the input mantissa and a constant (N). For example, for an input mantissa that can take on values between 0 and 128 (mₓ, 0≤mₓ<128), constant N may be equal to 128. In various embodiments, adder 402 may be replaced with OR logic to implement (e.g., 128 OR mₓ), for example, as illustrated in further examples below. The output of adder 402 is coupled to an input of right shifter 410. A shift input of right shifter 410, which controls the shift operation, is coupled to input exponent 451 thought a negation circuit (−x) 408, which receives the input exponent (eₓ) and produces a negative of the input exponent (−eₓ). For example, right shifter circuit 410 may produce a right shifted version of the input mantissa 450 having values between 0 and 128 as follows:

(128+mₓ) >>−(eₓ)

The above right shifter version of the input mantissa is a first output mantissa 460 for a value of 2^{x} for cases where the input sign bit is +1 and the input exponent is less than zero (0).

Input mantissa 450 is also coupled to an input of left shifter 412. A shift input of left shifter 412 is coupled to input exponent 451. Accordingly, left shifter 412 produces a left shifted version of the input mantissa. Lower bits of the left shifted version of the input mantissa form a modulus function. In this example, lower bits of the left shifted version of the input mantissa correspond to a second output mantissa 461 for a value of 2^{x} when the input sign bit is +1 and the input exponent is greater than or equal to zero (0) as follows:

(mₓ<<(eₓ))mod 128.

In this example, first and second output mantissas 460-461 are coupled to multiplexer (Mux) 416. An output of Mux 416 is coupled to an input of Mux 420, and an output of Mux 420 produces the final output mantissa. Muxes 416 and 420 have selection control signals, Select 0 and Select 1, based on the values of the input sign bit 452 and input exponent 451 to select one of output manitssas 460-461.

The right and left shifted versions of the input mantissas may be subtracted from a constant (M) to form additional output mantissas. In this example, the output of Mux 416 is coupled to constant subtraction logic circuit 418 (M−x), which subtracts the output of Mux 416 from a constant value (e.g., 127 for a mantissa having values between 0-128). Accordingly, the output of subtraction circuit may be either:

127 −(128+mₓ) >>−(eₓ), or

127 −(mₓ<<eₓ))mod 128.

These alternative outputs form third and fourth output mantissas for a value of 2^{x} when the input sign bit is −1 and the input exponent is positive or negative. Either output mantissa may be selected as the final output mantissas by Mux 420.

A plurality of output exponents may also be generated from shifter circuits. In various embodiments, output exponents may be produced from adding upper bits of the left shifted input mantissa to a value of two (2) raised to a power of the input exponent (2^{ex}). In this example, digital circuit 400 further includes left shifter circuit 414 having input coupled to a value of one (1) (e.g., a binary value of 1 or a bit value of 1) and a shift input coupled to the input exponent 451, where left shifting 1 by the input exponent results in 2^{ex}. The upper bits from left shifter 412 form an integer divide function (DIV). Thus, the outputs of shifter 412 and shifter 414 may be added in adder 422 to produce an output exponent 464 as follows:

2^{ex}+((mₓ<<(eₓ))mod 128).

The output of adder 422 is further coupled through a negation circuit (−1−x) 424 to produce another output exponent 465 as follows:

−2^{ex} −((mₓ<<(eₓ))mod 128) −1.

Finally, output exponent 464 is couple to a first input of Mux 432, output exponent 465 is coupled to a second input of Mux 432. Values of zero (0) 428 and negative one (−1) 430 are coupled to other inputs of Mux 432. The final output mantissas and exponents for 2^{x} may selected as follows:

TABLE 1

| | s_{y} | Exponent (e_{y}) | Mantissa (m_{y}) |
|---|---|---|---|
| sₓ = +1 and eₓ < 0 | +1 | 0 | (128 + mₓ) >> −(eₓ) |
| sₓ = +1 and eₓ ≥ 0 | +1 | 2^{e}^{ₓ} + ((mₓ << (eₓ_{)div 128)} | (mₓ << (eₓ))mod 128 |
| sₓ = −1 and eₓ < 0 | +1 | −1 | 127 − ((128 + mₓ) >> −(eₓ) |
| sₓ = −1 and eₓ ≥ 0 | +1 | −2^{e}^{ₓ} − ((mₓ << (eₓ_{)div 128) - 1} | 127 − ((mₓ << (eₓ))mod 128) |

Accordingly, digital circuit 400 further includes control logic 470 configured to receive the input exponent and the input sign bit and generate control signals (Select 0, Select 1) to a mantissa selection circuit (e.g., Muxes 416 and 420) and exponent selection circuit (e.g., Mux 432). Selection control signals Select 0 and Select 1 configure the multiplexers such that the output of Mux 420 is coupled to an output of the right shifter circuit 410 and an output of the Mux 432 is coupled to a zero (0) value 428 when the input sign bit is positive and the input exponent is less than 0. Additionally, selection control signals Select 0 and Select 1 configure the multiplexers such that the output of Mux 420 is coupled to lower bits of the left shifter circuit 412 and an output of the exponent selection circuit is coupled a sum of upper bits of the left shifter circuit 412 and a value of two (2) raised to a power corresponding to the input exponent when the input sign bit is positive and the input exponent is greater than or equal to 0. Next, selection control signals Select 0 and Select 1 configure the multiplexers such that the output of Mux 420 is coupled to an output of the right shifter circuit 410 through a constant subtraction logic circuit 418 and an output of the multiplexer 432 is coupled to a constant negative one (−1) value when the input sign bit is positive and the input exponent is less than 0. Finally, selection control signals Select 0 and Select 1 configure the multiplexers such that the output of Mux 420 is coupled to lower bits of the left shifter circuit through the constant subtraction logic circuit 418 and an output of the multiplexer 432 is coupled a negative of a sum of upper bits of left shifter circuit 412 and a value of two (2) raised to a power corresponding to the input exponent when the input sign bit is negative and the input exponent is greater than the first value.

Muxes 416, 420 and 432 are examples of selection circuits, and the other circuits in FIG. 4 are one example combinational logic mechanisms for receiving first digital bits representing an input mantissa of an input value and second digital bits representing an input exponent of the input value and generating a plurality of output mantissas and plurality of output exponents.

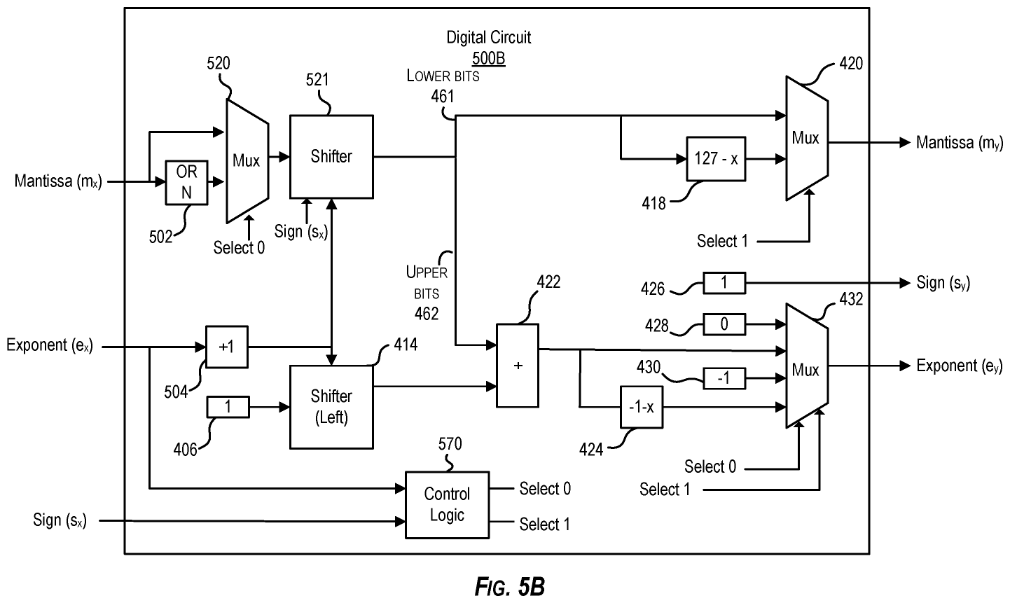

FIG. 5A illustrates an example digital circuit 500A for generating approximations of 4^{x} according to another embodiment. As illustrated in this example, the above-described techniques may be used to also implement a digital circuit for generating approximations of 4^{x}. For approximations of 4^{x}, the mantissa is shifted based on the input exponent added to a constant (e.g., ex+1). Thus, digital circuit 500A further includes a +1 adder circuit, which adds the value of 1 to the input exponent. In this example, the adder between the input mantissa and shifter 410 is replace with OR logic as mentioned above. The following table illustrates the behavior of digital circuit 500A:

TABLE 2

| | s_{y} | Exponent (e_{y}) | Mantissa (m_{y}) |
|---|---|---|---|
| sₓ = +1 and | +1 | 0 | (128 + mₓ) >> −(eₓ + 1) |
| eₓ< −1 | | | |
| sₓ = +1 and | +1 | 2^{e}^{ₓ}⁺¹ + ((mₓ << (eₓ + 1))div 128) | (mₓ << (eₓ + 1))mod 128 |
| ex > −1 | | | |
| sₓ = −1 and | +1 | −1 | 127 − ((128 + mₓ) >> −(eₓ + 1)) |
| eₓ< −1 | | | |
| sₓ = −1 and | +1 | −2^{e}^{ₓ}⁺¹ − ((mₓ << (eₓ + 1)) div 128) − 1 | 127 − ((mₓ << (eₓ + 1)) mod 128) |
| ex > −1 | | | |

Muxes 416, 420 and 432 are examples of selection circuits, and the other circuits in FIG. 5A are additional example combinational logic mechanisms for receiving first digital bits representing an input mantissa of an input value and second digital bits representing an input exponent of the input value and generating a plurality of output mantissas and plurality of output exponents.

FIG. 5B illustrates another example digital circuit 500B for generating approximations of 4^{x} according to another embodiment. In this example, Mux 418 is removed and Mux 520 has one input coupled to the input mantissa and another input coupled to the input mantissa through OR logic 502. In this example, shifter 521 is a bidirectional shifter, where the direction of the shift (left/right) is set by the shift polarity input (here, the input sign bit). For the shift polarity input s, shifting is (s==0: no shifting; S>0: shift s positions left; S<0: shift s positions right). The behavior of digital circuit 500B is the same shown in Table 2 above. Removing adder circuit (+1) 504 results in the same behavior as illustrated in Table 1 above.

Muxes 520, 420 and 432 are further examples of selection circuits, and the other circuits in FIG. 5B are additional example combinational logic mechanisms for receiving first digital bits representing an input mantissa of an input value and second digital bits representing an input exponent of the input value and generating a plurality of output mantissas and plurality of output exponents.

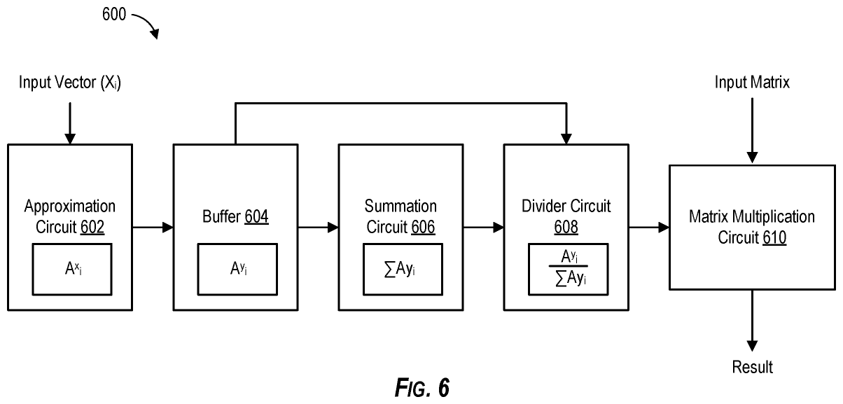

FIG. 6 illustrates a normalization system 600 according to an embodiment. In this example, an input vector is received by approximation circuit 602 for determining A^{x}, where A is a power of two (2). Circuit 602 may be implemented using one of the techniques above. Circuit 602 generates values of A^{x}, which may be used to determine a normalization function such as an approximation of the Softmax function. For example, values of A^{x} may be stored in buffer 604. The values may be added together in summation circuit 606. Divider circuit 608 may access values in buffer 604 and the summed value ΣA^{x} to produce normalized values: A^{x}/ΣA^{x}. The normalized values may, for example, be coupled to a matrix multiplication circuit 610. In some embodiments, the normalized values are used to process neural network data, for example.

The following illustrate how the above circuit behavior may approximate a Softmax function. The softmax function is defined as:

$$Softmax ( {x}_{i} ) = \frac{{e}^{{x}_{i}}}{\sum {e}^{{x}_{i}}} .$$

A function that is “similar” to e^{x}^{ᵢ} in Softmax, may have the following properties: easy to compute in floating point, strictly monotonous, and quickly growing. In this example, bfloatl6 is used as an example, but is extendible to fp32 and bfloat. A bfloat16 number is defined as:

$$x = {s}_{x} {2}^{{e}_{x}} ( 1 + \frac{{m}_{x}}{128} )$$

Where sₓ the sign of x (e.g., sₓ =+1 or sₓ =−1), eₓ the exponent of x (e.g., −7≤eₓ<=7), and mₓ the mantissa of x (e.g., 0≤mₓ <128). When calculating 2^{e}^{ₓ} in bfloat16, the result is 0 for eₓ<−7 and infinity for eₓ >7—so check can be performed at the boundaries —but no need to implement for large exponents. Also, for IEEE FP numbers, there is an exponent offset.

Softmax can be approximated using powers of 2. For example, Softmax₂ may be defined as follows:

$${Softmax}_{2} ( {x}_{i} ) = \frac{{2}^{{x}_{i}}}{\sum {2}^{{x}_{i}}} .$$

It may be noted that Softmax(x)=Softmax2(log 2(e)*x)=Softmax2(1.44*x). In other words, to get a better approximation, one can multiply x by 1.44 before invoking the circuitry that approximates 2^{x}.

Next, an approximation of 2^{x} may be as follows:

$${2}^{x} = {2}^{{s}_{x} {2}^{{e}_{x}} ( 1 + \frac{{m}_{x}}{128} )} = {( {2}^{( 1 + \frac{{m}_{x}}{128} )} )}^{{s}_{x} {2}^{{e}_{x}}}$$

Approximating

$${2}^{( 1 + \frac{{m}_{x}}{128} )} with 2 ( 1 + \frac{{m}_{x}}{128} ) .$$

### Then:

$$\text{Approx} \text{1:} {2}^{x} \approx {( 2 ( 1 + \frac{{m}_{x}}{128} ) )}^{{s}_{x} {2}^{{e}_{x}}} = {2}^{{s}_{x} {2}^{{e}_{x}}} {( 1 + \frac{{m}_{x}}{128} )}^{{s}_{x} {2}^{{e}_{x}}}$$

There are four cases for different values of the sign bit and input exponent:

Case A: sₓ =+1 and eₓ<0 (e.g., small positive numbers):

$${2}^{x} \approx {2}^{{2}^{{e}_{x}}} {( 1 + \frac{{m}_{x}}{128} )}^{{2}^{{e}_{x}}}$$

$${2}^{{2}^{{e}_{x}}} {( 1 + \frac{{m}_{x}}{128} )}^{{2}^{{e}_{x}}} = {( 1 + 1 )}^{{2}^{{e}_{x}}} {( 1 + \frac{{m}_{x}}{128} )}^{{2}^{{e}_{x}}} \approx ( 1 + \frac{( 128 ⪢ \vert {e}_{x} \vert )}{128} ) ( 1 + \frac{( {m}_{x} ⪢ \vert {e}_{x} \vert )}{128} ) \approx ( 1 + ( \frac{( 128 ⪢ \vert {e}_{x} \vert ) + ( {m}_{x} ⪢ \vert {e}_{x} \vert )}{128} ) )$$

Case B: sₓ =+1 and eₓ ≥0 (e.g., large positive numbers):

$${2}^{x} \approx {2}^{{2}^{{e}_{x}}} {( 1 + \frac{{m}_{x}}{128} )}^{{2}^{{e}_{x}}} \approx {2}^{{2}^{{e}_{x}}} ( 1 + \frac{{m}_{x}}{128} {2}^{{e}_{x}} ) \approx {2}^{{2}^{{e}_{x}}} ( 1 + \frac{{m}_{x}}{128} {2}^{{e}_{x}} )$$

$${2}^{x} \approx {2}^{{2}^{{e}_{x}}} ( 1 + \frac{{m}_{x}}{128} {2}^{{e}_{x}} ) \approx {2}^{{2}^{{e}_{x}} + ( ( {m}_{x} ⪡ \vert {e}_{x} \vert ) div 128 )} ( 1 + \frac{( {m}_{x} ⪡ \vert {e}_{x} \vert ) mod 128}{128} )$$

Note that the implementation is very simple, since this is shifting and “bit-picking” with −7≤eₓ<=7. (e.g., mₓ is left-shifted: the lower 7 bits are used in the mantissa and the upper bits are used in the exponent as mentioned above).

Case C: sₓ=−1 and eₓ<0 (e.g., small negative numbers):

$${2}^{x} \approx {2}^{- {2}^{{e}_{x}}} {( 1 + \frac{{m}_{x}}{128} )}^{- {2}^{{e}_{x}}}$$

$${2}^{x} \approx {2}^{- {2}^{{e}_{x}}} {( 1 + \frac{{m}_{x}}{128} )}^{- {2}^{{e}_{x}}} = {( 1 + 1 )}^{- {2}^{{e}_{x}}} {( 1 + \frac{{m}_{x}}{128} )}^{- {2}^{{e}_{x}}} \approx ( 1 - \frac{( 128 ⪢ \vert {e}_{x} \vert )}{128} ) ( 1 - \frac{( {m}_{x} ⪢ \vert {e}_{x} \vert )}{128} ) \approx ( 1 - ( \frac{( 128 ⪢ \vert {e}_{x} \vert ) + ( {m}_{x} ⪢ \vert {e}_{x} \vert )}{128} ) ) \approx {2}^{- 1} ( 1 + ( \frac{127 - ( 128 ⪢ \vert {e}_{x} \vert ) - ( {m}_{x} ⪢ \vert {e}_{x} \vert )}{128} ) )$$

Case D: sₓ=−1 and eₓ ≥0 (e.g., large negative numbers):

$${2}^{x} \approx {2}^{- {2}^{{e}_{x}}} {( 1 + \frac{{m}_{x}}{128} )}^{- {2}^{{e}_{x}}} \approx {2}^{- {2}^{{e}_{x}}} ( 1 - \frac{{m}_{x}}{128} {2}^{{e}_{x}} ) \approx {2}^{- {2}^{{e}_{x}} - ( ( {m}_{x} ⪡ \vert {e}_{x} \vert ) div 128 )} ( 1 - \frac{( {m}_{x} ⪡ \vert {e}_{x} \vert ) mod 128}{128} ) \approx {2}^{- {2}^{{e}_{x}} - ( ( {m}_{x} ⪡ \vert {e}_{x} \vert ) div 128 ) - 1} ( 1 + \frac{127 - ( {m}_{x} ⪡ \vert {e}_{x} \vert ) mod 128}{128} )$$

The following illustrates Softmax approximated using powers of 4. For example, Softmax4 may be defined as follows:

$${Softmax}_{4} ( {x}_{i} ) = \frac{{4}^{{x}_{i}}}{Σ {4}^{{x}_{i}}}$$

Now approximate 4^{x}^{ᵢ}.

$${4}^{x} = {4}^{{s}_{x} {2}^{{e}_{x}} ( 1 + \frac{{m}_{x}}{128} )} = {( {4}^{( 1 + \frac{{m}_{x}}{128} )} )}^{{s}_{x} {2}^{{e}_{x}}} ,$$

Approximate

$${4}^{( 1 + \frac{{m}_{x}}{128} )} with 4 {( 1 + \frac{{m}_{x}}{128} )}^{2} . \\ {4}^{x} \approx {( 4 {( 1 + \frac{{m}_{x}}{128} )}^{2} )}^{{s}_{x} {2}^{{e}_{x}}} = {4}^{{s}_{x} {2}^{{e}_{x}}} {( 1 + \frac{{m}_{x}}{128} )}^{2 {s}_{x} {2}^{{e}_{x}}} = {2}^{{s}_{x} {2}^{{e}_{x} + 1}} {( 1 + \frac{{m}_{x}}{128} )}^{{s}_{x} {2}^{{e}_{x} + 1}}$$

Case A: sₓ =+1 and eₓ<−1 (e.g., small positive numbers):

$${4}^{x} \approx {2}^{{2}^{{e}_{x} + 1}} {( 1 + \frac{{m}_{x}}{128} )}^{{2}^{{e}_{x} + 1}} = {( 1 + 1 )}^{{2}^{{e}_{x} + 1}} {( 1 + \frac{{m}_{x}}{128} )}^{{2}^{{e}_{x} + 1}} \approx ( 1 + {2}^{{e}_{x} + 1} ) ( 1 + \frac{{m}_{x} {2}^{{e}_{x} + 1} )}{128} ) \approx ( 1 + {2}^{{e}_{x} + 1} + \frac{{m}_{x} {2}^{{e}_{x} + 1} )}{128} ) = ( 1 + \frac{128 * {2}^{{e}_{x} + 1} + {m}_{x} {2}^{{e}_{x} + 1} )}{128} ) \approx ( 1 + ( \frac{( 128 + {m}_{x} ) ⪢ - ( {e}_{x} + 1 )}{128} ) )$$

Case B: sₓ =+1 and eₓ ≥−1 (e.g., large positive numbers):

$${4}^{x} \approx {2}^{{2}^{{e}_{x} + 1}} {( 1 + \frac{{m}_{x}}{128} )}^{{2}^{{e}_{x} + 1}} \approx {2}^{{2}^{{e}_{x} + 1}} ( 1 + \frac{{m}_{x}}{128} {2}^{{e}_{x} + 1} ) \approx {2}^{{2}^{{e}_{x} + 1} + ( ( {m}_{x} ⪡ ( {e}_{x} + 1 ) ) div 128 )} ( 1 + \frac{( {m}_{x} ⪡ ( {e}_{x} + 1 ) ) mod 128}{128} )$$

Again, the implementations comprise shifting and “bit-picking” with −7≤eₓ <=7. (e.g., mₓ is left-shifted: the lower 7 bits may be used in the mantissa and the upper bits are used in the exponent).

Case C: sₓ =−1 and eₓ<−1 (e.g., small negative numbers):

$${4}^{x} \approx {2}^{- {2}^{{e}_{x} + 1}} {( 1 + \frac{{m}_{x}}{128} )}^{- {2}^{{e}_{x} + 1}} = {( 1 + 1 )}^{- {2}^{{e}_{x} + 1}} {( 1 + \frac{{m}_{x}}{128} )}^{- {2}^{{e}_{x} + 1}} \approx ( 1 - {2}^{{e}_{x} + 1} ) ( 1 - \frac{{m}_{x} {2}^{{e}_{x} + 1} )}{128} ) \approx ( 1 - {2}^{{e}_{x} + 1} - \frac{{m}_{x} {2}^{{e}_{x} + 1} )}{128} ) \approx ( 1 - \frac{128 * {2}^{{e}_{x} + 1} + {m}_{x} {2}^{{e}_{x} + 1} )}{128} ) \approx {2}^{- 1} ( 1 + ( \frac{127 - ( ( 128 + {m}_{x} ) ⪢ - ( {e}_{x} + 1 ) )}{128} ) )$$

Case D: sₓ =−1 and eₓ ≥−1 (e.g., large negative numbers):

$${4}^{x} \approx {2}^{- {2}^{{e}_{x} + 1}} {( 1 + \frac{{m}_{x}}{128} )}^{- {2}^{{e}_{x} + 1}} \approx {2}^{- {2}^{{e}_{x} + 1}} ( 1 - \frac{{m}_{x}}{128} {2}^{{e}_{x} + 1} ) \approx {2}^{- {2}^{{e}_{x} + 1} - ( ( {m}_{x} ⪡ ( {e}_{x} + 1 ) div 128 ) - 1} ( 1 + \frac{127 - ( ( {m}_{x} ⪡ ( {e}_{x} + 1 ) mod 128 )}{128} )$$

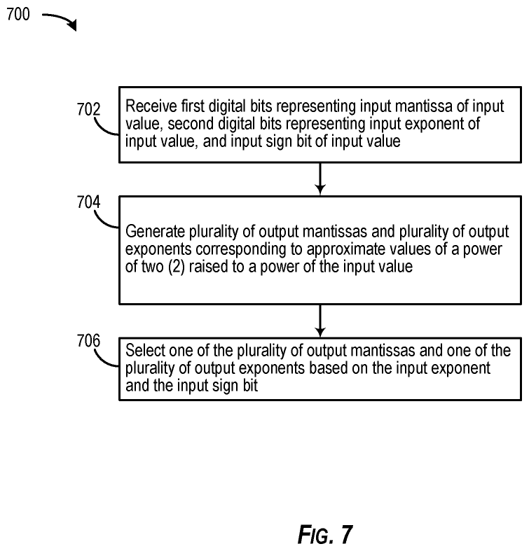

FIG. 7 illustrates a method 700 according to an embodiment. At 702, first digital bits and second digital bits are received in a digital circuit. The first digital bits represent a mantissa of an input value, and the second digital bits represent an exponent of the input value. The input value may be in a floating point format, for example, and further include a sign bit. At 702, a plurality of output mantissas and plurality of output exponents are generated. The output mantissas and output exponents correspond to approximate values of a power of two (2) raised to a power of the input value x (e.g., 2^{x}, 4^{x}, . . . ). At 706, one of the plurality of output mantissas and one of the plurality of output exponents are selected based on the input exponent and the input sign bit. Accordingly, the method 700 generates digital values (e.g., in a floating point format) corresponding to an approximation of 2^{x}, 4^{X}, etc., which may be used to approximate a Softmax function in a neural network, for example. The circuits for outputting digital values approximating a power of 2 raised to a power of an input value may also be used in other applications.

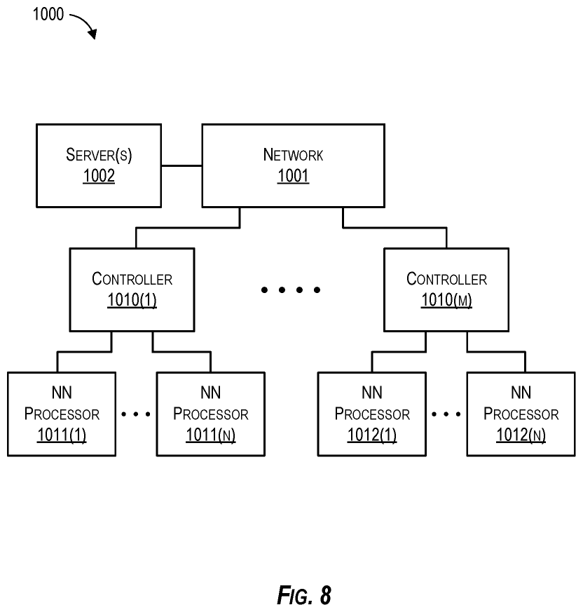

FIG. 8 illustrates a neural network processing system according to some embodiments. In various embodiments, neural networks according to the present disclosure may be implemented and trained in a hardware environment comprising one or more neural network processors. A neural network processor may refer to various graphics processing units (GPU) (e.g., a GPU for processing neural networks produced by Nvidia Corp®), field programmable gate arrays (FPGA) (e.g., FPGAs for processing neural networks produced by Xilinx®), or a variety of application specific integrated circuits (ASICs) or neural network processors comprising hardware architectures optimized for neural network computations, for example. In this example environment, one or more servers 1002, which may comprise architectures illustrated in FIG. 9 above, may be coupled to a plurality of controllers 1010(1)−1010(M) over a communication network 1001 (e.g. switches, routers, etc.). Controllers 1010(1)−1010(M) may also comprise architectures illustrated in FIG. 9 above. Each controller 1010(1)−1010(M) may be coupled to one or more NN processors, such as processors 1011(1)-1011(N) and 1012(1)-1012(N), for example. NN processors 1011(1)-1011(N) and 1012(1)-1012(N) may include a variety of configurations of functional processing blocks and memory optimized for neural network processing, such as training or inference. NN processors in FIG. 8 may include digital circuits described herein for normalizing values (e.g., an approximation of the Softmax function). The NN processors are optimized for neural network computations. Server 1002 may configure controllers 1010 with NN models as well as input data to the models, which may be loaded and executed by NN processors 1011(1)-1011(N) and 1012(1)-1012(N) in parallel, for example. Models may include layers and associated weights as described above, for example. NN processors may load the models and apply the inputs to produce output results. NN processors may also implement training algorithms, for example. Digital circuits described herein may be used in both training and inference, for example.

### FURTHER EXAMPLE EMBODIMENTS

In various embodiments, the present disclosure includes systems, methods, and apparatuses for generating approximated values that may be used for normalization. The following examples may be used alone or in various combinations.

In one embodiment, the present disclosure includes a digital circuit comprising: combinational logic receiving first digital bits representing an input mantissa of an input value and second digital bits representing an input exponent of the input value, the combinational logic generating a plurality of output mantissas and plurality of output exponents corresponding to an approximate value of a power of two (2) raised to a power of the input value when the input value is positive and negative and when the input exponent is above and below a first value; and two or more selection circuits configured to receive the plurality of output mantissas and the plurality of output exponents, the selection circuits comprising selection control inputs coupled to the input exponent and an input sign bit of the input value to select one of the plurality of output mantissas and one of the plurality of output exponents.

In another embodiment, the present disclosure includes a method for generating normalized values comprising: receiving, in combinational logic comprising one or more shifter circuits, first digital bits representing an input mantissa of an input value and second digital bits representing an input exponent of the input value; generating, in the combinational logic, a plurality of output mantissas and plurality of output exponents corresponding to an approximate value of a power of two (2) raised to a power of the input value when the input value is positive and negative and when the input exponent is above and below a first value; and selecting, by two or more selection circuits configured to receive the plurality of output mantissas and the plurality of output exponents, one of the plurality of output mantissas and one of the plurality of output exponents based on the input exponent and an input sign bit of the input value.

In another embodiment, the present disclosure includes digital circuit comprising: combinational logic means for receiving first digital bits representing an input mantissa of an input value and second digital bits representing an input exponent of the input value, the combinational logic means generating a plurality of output mantissas and plurality of output exponents corresponding to an approximate value of a power of two (2) raised to a power of the input value when the input value is positive and negative and when the input exponent is above and below a first value; and selection circuit means for receiving the plurality of output mantissas and the plurality of output exponents and selecting one of the plurality of output mantissas and one of the plurality of output exponents based on the input exponent and an input sign bit of the input value.

In one embodiment, the combinational logic generates a plurality of shifted versions of the input mantissa based on the input exponent to produce the plurality of output mantissas and the plurality of output exponents.

In one embodiment, the two or more selection circuits produce: a first output mantissa comprising a sum of a first shifted version of the input mantissa and a first constant and a first output exponent having a zero value when the input sign bit is positive and the input exponent is less than a first value; a second output mantissa comprising a modulus of a second shifted version of the input mantissa and a second output exponent having a digital value of one (1) shifted based on the input exponent added to an integer division of the second shifted version of the input mantissa when the input sign bit is positive and the input exponent is greater than the first value; a third output mantissa comprising the sum of the first shifted version of the input mantissa the first constant, subtracted from a second constant, and a third output exponent having negative one (−1) value when the input sign bit is negative and the input exponent is less than the first value; and a fourth output mantissa comprising a modulus of the second shifted version of the input mantissa, subtracted from the second constant, and a negation of the second output exponent minus one (1) when the input sign bit is negative and the input exponent is greater than the first value.

In one embodiment, the combinational logic comprises one or more shifter circuits having an input coupled to the input mantissa and a shift input coupled to the input exponent, wherein the one or more shifter circuits produce left and right shifted versions of the input mantissa.

In one embodiment, a right shifted version of the input mantissa is used to form a first output mantissa and a second output mantissa, and wherein lower bits of a left shifted version of the input mantissa are used to form a third output mantissa and a fourth output mantissa.

In one embodiment, the right shifted version of the input mantissa is subtracted from a constant to form the second output mantissa.

In one embodiment, the left shifted version of the input mantissa is subtracted from a constant to form the fourth output mantissa.

In one embodiment, upper bits of a left shifted version of the input mantissa is used to form a first output exponent and a second output exponent.

In one embodiment, the upper bits of the left shifted version of the input mantissa is added to a value generated based on the input exponent to form the first output exponent and the second output exponent.

In one embodiment, the value generated based on the input exponent comprises a bit left shifted based on the input exponent.

In one embodiment, said added upper bits of the left shifted version of the input mantissa and the value generated based on the input exponent are negated to produce the second output exponent.

In one embodiment, the one or more shifter circuits comprise barrel shifter circuits.

In one embodiment, the one or more shifter circuits comprise: a right shifter circuit having a first input coupled to the input mantissa through a logic circuit configured to add the input mantissa to a constant and a shift input coupled to the input exponent through a logic circuit configured to negate the input exponent; and a first left shifter circuit having a first input coupled to receive the input mantissa and a shift input coupled to the input exponent.

In one embodiment, the one or more shifter circuits further comprise a second left shifter circuit having a first input coupled to receive a digital value of one (1) and a shift input coupled to the input exponent, wherein an output of the first left shifter circuit and the second left shifter circuit are added together.

In one embodiment, the two or more selection circuits comprise a first multiplexer having a first input coupled to an output of the right shifter circuit and a second input coupled to lower bits of the first left shifter circuit.

In one embodiment, the two or more selection circuits further comprise a second multiplexer having a first input coupled an output of the first multiplexer and a second input coupled to the output of the first multiplexer through a logic circuit configured to subtract a value on an input of the logic circuit from a constant.

In one embodiment, the two or more selection circuits comprise a multiplexer, the multiplexer comprising: a first input coupled to a sum of upper bits of the first left shifter circuit and a value of two (2) raised to a power corresponding to the exponent; a second input coupled to a negative version of the sum; a third input coupled to a zero (0) value; and a fourth input coupled to a negative one (−1) value; and an output producing a final output exponent.

In one embodiment, the digital circuit further comprises control logic configure to receive the input exponent and the input sign bit and generate control signals to at least a mantissa selection circuit and an exponent selection circuit, wherein: an output of the mantissa selection circuit is coupled to an output of the right shifter circuit and an output of the exponent selection circuit is coupled to a zero (0) value when the input sign bit is positive and the input exponent is less than a first value; an output of the mantissa selection circuit is coupled to lower bits of the left shifter circuit and an output of the exponent selection circuit is coupled a sum of upper bits of the first left shifter circuit and a value of two (2) raised to a power corresponding to the input exponent when the input sign bit is positive and the input exponent is greater than the first value; an output of the mantissa selection circuit is coupled to an output of the right shifter circuit through a constant subtraction logic circuit and an output of the exponent selection circuit is coupled to a constant negative one (−1) value when the input sign bit is positive and the input exponent is less than a first value; an output of the mantissa selection circuit is coupled to lower bits of the left shifter circuit through the constant subtraction logic circuit and an output of the exponent selection circuit is coupled a negative of a sum of upper bits of the first left shifter circuit and a value of two (2) raised to a power corresponding to the input exponent when the input sign bit is negative and the input exponent is greater than the first value.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations, and equivalents may be employed without departing from the scope of the present disclosure as defined by the claims.

What is claimed is:

1. A digital circuit comprising:
combinational logic receiving first digital bits representing an input mantissa of an input value and second digital bits representing an input exponent of the input value, the combinational logic generating a plurality of output mantissas and plurality of output exponents corresponding to an approximate value of a power of two (2) raised to a power of the input value when the input value is positive and negative and when the input exponent is above and below a first value; and
two or more selection circuits configured to receive the plurality of output mantissas and the plurality of output exponents, the selection circuits comprising selection control inputs coupled to the input exponent and an input sign bit of the input value to select one of the plurality of output mantissas and one of the plurality of output exponents.

2. The digital circuit of claim 1, wherein the combinational logic generates a plurality of shifted versions of the input mantissa based on the input exponent to produce the plurality of output mantissas and the plurality of output exponents.

3. The digital circuit of claim 1, wherein the two or more selection circuits produce:
a first output mantissa comprising a sum of a first shifted version of the input mantissa and a first constant and a first output exponent having a zero value when the input sign bit is positive and the input exponent is less than a first value;
a second output mantissa comprising a modulus of a second shifted version of the input mantissa and a second output exponent having a digital value of one (1) shifted based on the input exponent added to an integer division of the second shifted version of the input mantissa when the input sign bit is positive and the input exponent is greater than the first value;
a third output mantissa comprising the sum of the first shifted version of the input mantissa the first constant, subtracted from a second constant, and a third output exponent having negative one (−1) value when the input sign bit is negative and the input exponent is less than the first value; and
a fourth output mantissa comprising a modulus of the second shifted version of the input mantissa, subtracted from the second constant, and a negation of the second output exponent minus one (1) when the input sign bit is negative and the input exponent is greater than the first value.

4. The digital circuit of claim 1, wherein the combinational logic comprises one or more shifter circuits having an input coupled to the input mantissa and a shift input coupled to the input exponent, wherein the one or more shifter circuits produce left and right shifted versions of the input mantissa.

5. The digital circuit of claim 4, wherein a right shifted version of the input mantissa is used to form a first output mantissa and a second output mantissa, and wherein lower bits of a left shifted version of the input mantissa are used to form a third output mantissa and a fourth output mantissa.

6. The digital circuit of claim 5, wherein the right shifted version of the input mantissa is subtracted from a constant to form the second output mantissa.

7. The digital circuit of claim 5, wherein the left shifted version of the input mantissa is subtracted from a constant to form the fourth output mantissa.

8. The digital circuit of claim 4, wherein upper bits of a left shifted version of the input mantissa is used to form a first output exponent and a second output exponent.

9. The digital circuit of claim 8, wherein the upper bits of the left shifted version of the input mantissa is added to a value generated based on the input exponent to form the first output exponent and the second output exponent.

10. The digital circuit of claim 9, wherein the value generated based on the input exponent comprises a bit left shifted based on the input exponent.

11. The digital circuit of claim 9, wherein said added upper bits of the left shifted version of the input mantissa and the value generated based on the input exponent are negated to produce the second output exponent.

12. The digital circuit of claim 4, wherein the one or more shifter circuits comprise barrel shifter circuits.

13. The digital circuit of claim 4, wherein the one or more shifter circuits comprise:
a right shifter circuit having a first input coupled to the input mantissa through a logic circuit configured to add the input mantissa to a constant and a shift input coupled to the input exponent through a logic circuit configured to negate the input exponent; and
a first left shifter circuit having a first input coupled to receive the input mantissa and a shift input coupled to the input exponent.

14. The digital circuit of claim 13, wherein the one or more shifter circuits further comprise a second left shifter circuit having a first input coupled to receive a digital value of one (1) and a shift input coupled to the input exponent, wherein an output of the first left shifter circuit and the second left shifter circuit are added together.

15. The digital circuit of claim 13, wherein the two or more selection circuits comprise a first multiplexer having a first input coupled to an output of the right shifter circuit and a second input coupled to lower bits of the first left shifter circuit.

16. The digital circuit of claim 15, wherein the two or more selection circuits further comprise a second multiplexer having a first input coupled an output of the first multiplexer and a second input coupled to the output of the first multiplexer through a logic circuit configured to subtract a value on an input of the logic circuit from a constant.

17. The digital circuit of claim 13, wherein the two or more selection circuits comprise a multiplexer, the multiplexer comprising:
a first input coupled to a sum of upper bits of the first left shifter circuit and a value of two (2) raised to a power corresponding to the exponent;
a second input coupled to a negative version of the sum;
a third input coupled to a zero (0) value; and
a fourth input coupled to a negative one (−1) value; and
an output producing a final output exponent.

18. The digital circuit of claim 13, further comprising control logic configure to receive the input exponent and the input sign bit and generate control signals to at least a mantissa selection circuit and an exponent selection circuit, wherein:
an output of the mantissa selection circuit is coupled to an output of the right shifter circuit and an output of the exponent selection circuit is coupled to a zero (0) value when the input sign bit is positive and the input exponent is less than a first value;
an output of the mantissa selection circuit is coupled to lower bits of the left shifter circuit and an output of the exponent selection circuit is coupled a sum of upper bits of the first left shifter circuit and a value of two (2) raised to a power corresponding to the input exponent when the input sign bit is positive and the input exponent is greater than the first value;
an output of the mantissa selection circuit is coupled to an output of the right shifter circuit through a constant subtraction logic circuit and an output of the exponent selection circuit is coupled to a constant negative one (−1) value when the input sign bit is positive and the input exponent is less than a first value;
an output of the mantissa selection circuit is coupled to lower bits of the left shifter circuit through the constant subtraction logic circuit and an output of the exponent selection circuit is coupled a negative of a sum of upper bits of the first left shifter circuit and a value of two (2) raised to a power corresponding to the input exponent when the input sign bit is negative and the input exponent is greater than the first value.

19. A method for generating normalized values comprising:
receiving, in combinational logic comprising one or more shifter circuits, first digital bits representing an input mantissa of an input value and second digital bits representing an input exponent of the input value;
generating, in the combinational logic, a plurality of output mantissas and plurality of output exponents corresponding to an approximate value of a power of two (2) raised to a power of the input value when the input value is positive and negative and when the input exponent is above and below a first value; and
selecting, by two or more selection circuits configured to receive the plurality of output mantissas and the plurality of output exponents, one of the plurality of output mantissas and one of the plurality of output exponents based on the input exponent and an input sign bit of the input value.

20. A digital circuit comprising:
combinational logic means for receiving first digital bits representing an input mantissa of an input value and second digital bits representing an input exponent of the input value, the combinational logic means generating a plurality of output mantissas and plurality of output exponents corresponding to an approximate value of a power of two (2) raised to a power of the input value when the input value is positive and negative and when the input exponent is above and below a first value; and
selection circuit means for receiving the plurality of output mantissas and the plurality of output exponents and selecting one of the plurality of output mantissas and one of the plurality of output exponents based on the input exponent and an input sign bit of the input value.
